(19) United States
(12) Patent Application Publication
(10) Pub. No.: US 2004/0227476 A1
(43) Pub. Date: Nov. 18, 2004

(54) Flexible inverter power module for motor drives

(75) Inventors: Alberto Guerra, Palos Verdes Estates, CA (US); Neeraj Keskar, Atlanta, GA (US)

Correspondence Address: OSTROLENK FABER GERB & SOFFEN, 1180 AVENUE OF THE AMERICAS, NEW YORK, NY, 100368403

(73) Assignee: International Rectifier Corp.

(21) Appl. No.: 10/738,005

(22) Filed: Dec. 16, 2003

Related U.S. Application Data
(60) Provisional application No. 60/434,932, filed on Dec. 19, 2002.
(60) Provisional application No. 60/447,634, filed on Feb. 14, 2003.

(51) Int. Cl. H02P 5/06

(52) U.S. Cl. 318/254

(57) ABSTRACT

An inverter power module for driving an electric motor comprising a plurality of motor drive power switches having at least one output for driving the motor, a driver integrated circuit for driving the plurality of motor drive power switches, the plurality of switches comprising at least two power switches arranged in a half bridge configuration adapted to be connected between rails of a supply bus, with a common connection between the switches serving as an output for driving the motor, the switches comprising a high side switch and a low side switch, the low side switch being connected to an external terminal of the module adapted to be connected through a sensing element to the lower potential supply bus rail, whereby a motor current can be monitored at the external connection.

### CROSS REFERENCE TO RELATED APPLICATIONS

The present application claims the priority and benefit of U.S. Provisional patent applications S. No. 60/434,932 filed Dec. 19, 2002 entitled “A NEW LOW-COST FLEXIBLE IGBT INVERTER POWER MODULE FOR APPLIANCE APPLICATIONS” and S. No. 60/447,634 filed Feb. 14, 2003 entitled INTELLIGENT POWER MODULE FOR AC MOTOR DRIVES, the entire disclosures of which are incorporated herein by reference.

### BACKGROUND OF THE INVENTION

The present invention relates to motor drives, and in particular electronic power modules for AC motor drives. Some home appliances like washing machines and refrigerators include three-phase ac motors to get the maximum performance out of these machines. Generating the right amount of power at the appropriate phase to drive these motors is not a trivial task. Furthermore, there are challenges with respect to attaining high reliability and safe operation under rigorous conditions, with minimal emissions to meet EMI (electromagnetic interference) limits. All this requires a good system understanding, as well as the technologies needed to generate accurately the power to drive them. Concurrently, market pressures are demanding higher performance and ruggedness from a smaller footprint at lower cost. As the window of opportunity is getting shorter, and time-to-market is often critical, system developers are under tremendous pressure to speed-up the development time and deliver the final product to the market on a timely basis.

Appliance engineers need a design approach that simplifies development of three-phase, variable speed motor drives for efficient washers, refrigerators, air conditioners and other home appliances. Variable speed motor drives use electronic circuits to vary the motor speed instead of the less reliable mechanical speed changing employed in older generation appliances. In addition, varying speed under electronic control saves energy by reducing speed when higher speeds are not necessary. For example, instead of a refrigerator cycling on and off to regulate its internal temperature, it can vary the speed to maintain a constant temperature. Power consumption is less at lower speed than at higher speed.

Although a conventional approach using discrete components and planar insulated gate bipolar transistor (IGBTs) can meet the power requirements, it requires large printed circuit board space. Also, the conventional discrete approach requires a higher component count. The higher number of parts adds to the complexity of the design task, increasing the development time rather than reducing it.

The quest for the efficient use of power has taken on even greater importance over the past decade and, as over half the world's electricity is consumed by electric motors, motion control applications offer more opportunities for power savings in the near future. In particular, there is a growing pressure on designers to improve efficiencies of motor drives in applications such as elevators, refrigerators, air conditioners, washing machines, and factory automation. Due to cost, the vast majority of the motors used in these applications do not have electronic controls. For example, the typical refrigerator uses a bimetallic switch to turn on the motor when the temperature gets too hot and to turn the motor off when the temperature gets too cold. This method of control typically wastes up to half of the energy consumption of the application. Given the tremendous energy savings potential of a more efficient motor drive solution, one would anticipate an eager mass adoption of solutions to achieve increased efficiency levels. However, to date this has not really been the case. Among the reasons for this are the increasing complexity needed in the drive design to meet energy efficiency and power quality regulations, which in turn drives up cost. At the same time, consumers are demanding more comfort and safety features that require higher levels of performance meaning greater complexity and again greater cost.

Newer approaches are needed to tackle these challenges, and give system designers a solution that saves energy, increases efficiency and reduces costs, while cutting the overall development time and risks. It is accordingly, desirable to provide an advanced power module using advances in semiconductor designs and in packaging with built-in intelligence to overcome the limitations of older three-phase inverter solutions using discrete parts and to facilitate driving three-phase motors in consumer appliances like washing machines, refrigerators and air conditioners, etc.

### SUMMARY OF THE INVENTION

Accordingly, it is an object of the present invention to realize an advanced intelligent power module (AIPM) for motor control applications. The present invention combines the latest refinements in low-loss, high-voltage IGBT and driver ICs with advances in packaging technology to deliver a compact electronic motor drive solution. Besides integrating all the high-voltage power transistors and associated driver electronics in a single isolated compact package, the invention also incorporates protection features to ensure high levels of fail-safe operation and system reliability. Additionally the module is designed to operate from a single polarity supply to further simplify its utilization in motor control applications, thereby accelerating the development of the final product, and enabling manufacturers to meet the critical time-to-market demands.

As electromagnetic compatibility is important, proper attention must be paid to layout and shielding to minimize EMI (electromagnetic interference), which is further aided by shorter interconnects and less wiring inside the module. As bare dies are mounted as close as possible, and highly integrated ICs are employed in the module of the invention, the interconnects are substantially shortened, while significantly fewer wires are needed to connect the dies to the pads and I/Os to the outside pins. Furthermore, the module of the invention is constructed to ensure that there is no fault caused by ground bounce or cross-talk. In short, a single AIPM eases all the tedious and laborious work for the engineer developing a complete motor-control system. Over and above, the inventory requirements are substantially simplified. Unlike the discrete approach, where the engineer has to keep an account of many components on the board in order to complete the power drive for the ac motor, the present invention reduces the task to a single module and associated bootstrap capacitors, in the embodiment described, three bootstrap capacitors.

Preferably, to provide a compact, high-performance three-phase inverter in a single isolated single-in-line package (SIP), the module of the invention exploits low-cost insulated metal substrate technology (IMST). The IMST uses over-molded plastic with high thermal conductivity to facilitate the compact assembly of a wide range of components, which include power dies, driver chip, and other surface mountable passive and active discrete components. To provide adequate shielding and reduce EMI, the aluminum plate in this assembly is held at ground potential. This also enables the dies in the module to spread the heat rapidly and maintain specified temperature ratings.

Insulated Metal Substrate Technology (IMST) originally was developed as a low cost method for mounting bare chips. It is useful for achieving high performance and high reliability in high-density solutions. The IMST substrate uses an aluminum plate as the base. The upper side of the substrate forms a sandwich of a high voltage dielectric and a copper cladding on which the circuit is etched, similar to a conventional printed wiring board. This allows the creation of hybrid ICs that take advantage of two primary features of the aluminum substrate, namely high thermal conductivity and simple machining.

The gap between increasing complexity and the consumer demand for lower cost, faster product development cycles and increased efficiencies can be bridged by the adoption of the present invention. Benefits from the invention include more than 40% reduction in overall motion control system cost and more than 50% reduction in motion control product development time. Thus, the engineering challenge to provide energy-efficient variable speed motor control simply and cost effectively can be achieved, and ultimately, the percentage of energy used to drive the world's electric motors can be reduced.

The electronics industry is presently in a “high-density mounting” period in which progress is being made at phenomenal rates. In order to obtain high power density, the power module of the invention represents a sophisticated, integrated solution. It enables the integration of 3 phase motor drives used in a variety of appliances, such as washing machines, energy efficient refrigerators and air conditioning compressor drives. The modules preferably utilize non-punch-through (NPT) IGBT technology matched with hyperfast diodes, while minimizing EMI generation. In addition to the IGBT power switches, the modules contain a 6-output monolithic gate driver chip, matched to the drive requirements of the IGBTs to generate the most efficient power switch consistent with minimum noise generation and maximum ruggedness. All these components are mounted on the Insulated Metal Substrate (IMS).

Other features and advantages of the present invention will become apparent from the following description of the invention which refers to the accompanying drawings.

### BRIEF DESCRIPTION OF THE DRAWING(S)

The invention will now be described in greater detail in the following detailed description with reference to the drawings in which:

FIG. 1 is a schematic diagram of the intelligent power module of the invention;

FIG. 1(a) shows switching current waveforms at IGBT turn on for the circuit of FIG. 1 and for a prior art system;

FIG. 1(b) shows switching current wave forms at IGBT turn off for the circuit of FIG. 1 and for the prior art;

FIG. 2 shows switching dv/dt for the circuit of FIG. 1 and for the prior art;

FIG. 3 shows switching energy comparisons for the invention and the prior art;

FIG. 4 shows on-state voltage drop V_{CEON} for the invention and the prior art;

FIG. 5 shows current averaging for a sinusoidal current;

FIG. 6 shows average power loss variation in a single IGBT/diode within a half period of a sine cycle;

FIG. 7(a) shows IGBT power loss at a junction temperature of 25° C. for NPT and PT IGBTs;

FIG. 7(b) shows IGBT power loss at a junction temperature of 125° C. for NPT and PT IGBTs;

FIG. 8 schematically shows the physical power module structure;

FIG. 8A shows further details of the power module structure;

FIG. 9 shows differential mode noise path in the module of the invention;

FIG. 10 shows common mode noise path in the module of the invention;

FIG. 11 shows typical single point parallel ground connections;

FIG. 12 shows conducted EMI in an air conditioner application with the input EMI filter disconnected for both the invention and a prior art circuit;

FIG. 13 shows conducted EMI in an air conditioner application with the input EMI filter connected for both the invention and a prior art cirucit;

FIG. 14 shows reverse bias SOA (safe operating area) of the IGBTs used; and

FIG. 15 shows how the power module of the present invention can be connected for evaluation in an evaluation system.

### DETAILED DESCRIPTION OF PREFERRED EMBODIMENTS

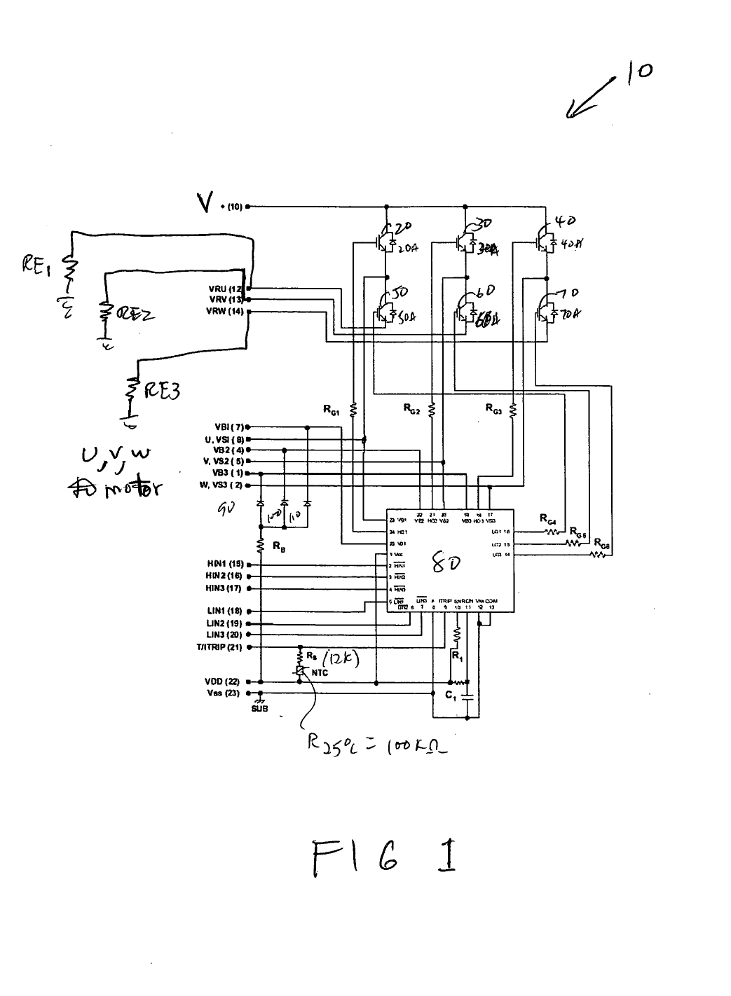

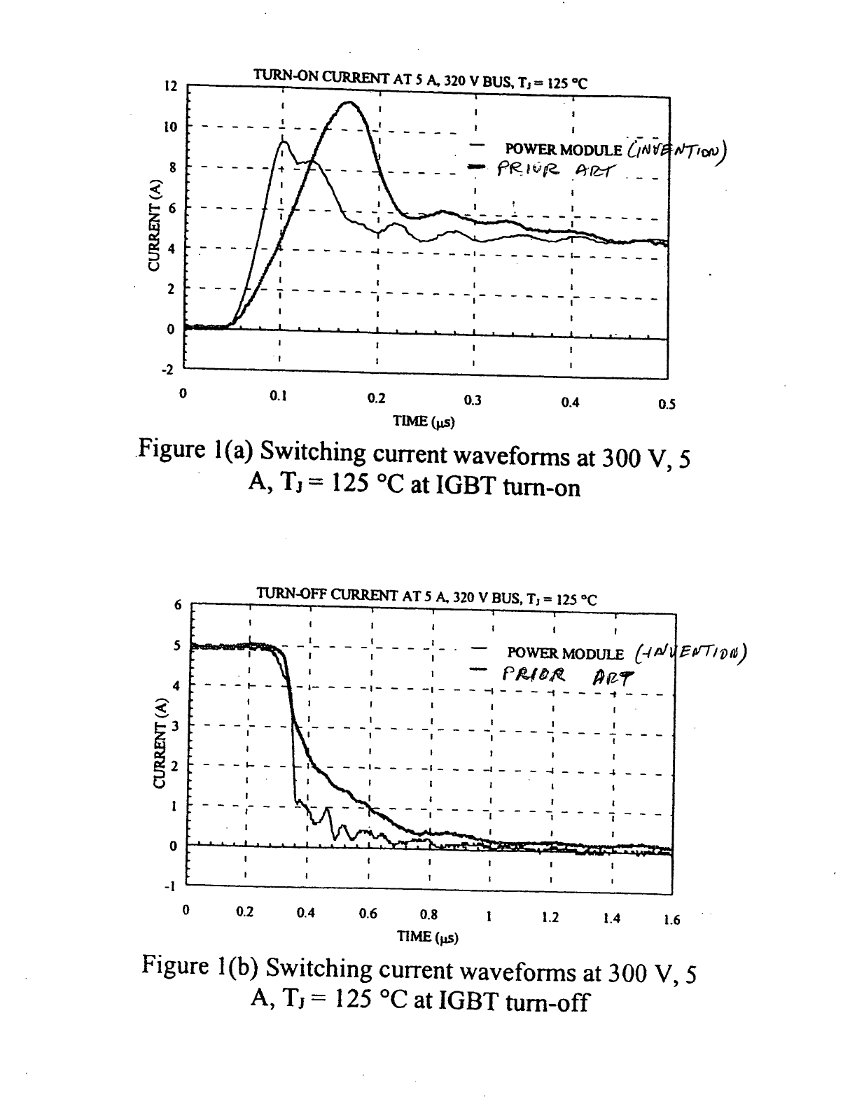

With reference now to the drawings, FIG. 1 shows a schematic diagram of the motor drive module 10 of the invention. The module contains six IGBT dies 20, 30, 40, 50, 60, 70 each with its own discrete gate resistor RG1, RG2, RG3, RG4, RG5, RG6, respectively, six commutation diode dies 20A, 30A, 40A, 50A, 60A, 70A, one three-phase monolithic, level shifting driver chip 80, three bootstrap diodes 90, 100, 110 with a current limiting resistor RB and an NTC thermistor/resistor pair NTC-RS for over-temperature protection. The NTC-RS pair are connected to an input T/ITRIP. This input functions also for overcurrent and/or overvoltage protection. The overcurrent/overvoltage trip circuit responds to an input signal T/ITRIP generated from an external sense element such as a current transformer or sense resistor. The input pin T/ITRIP for the trip circuit performs a dual function as an input pin for overcurrent/overvoltage trip voltage and an output pin for the module analog temperature sensing thermistor NTC. The module schematic of FIG. 1 includes preferred values of the thermistor and its associated components to facilitate the design of external circuitry.

A resistor RB is included in the bootstrap circuit to limit peak currents in the bootstrap diodes especially when using large value bootstrap capacitors, which are necessary under certain operating conditions. Preferably the bootstrap diodes are integrally mounted on the module board. The integration of the bootstrap diodes and RB into the module improves noise immunity by reducing −Vs spikes. Preferably, the bootstrap diodes have a low Vf and a soft recovery characteristic optimized to limit the voltage drop of the VCC and reducing noise during the capacitor charge-discharge cycle. The power module integrates the driver and the power stages into an isolated module including circuits to generate timing, speed and direction PWM or PFM information to complete the motor drive function. 5-volt logic systems are generally preferred from a noise immunity standpoint but the module may also accept 3.3V logic or any signal level up to Vcc (+15V). The driver may be, for example, a type IR21365 monolithic driver IC with inputs having pull-up resistors to the internal 5V reference and requiring a logic low to command an output. The pull-down current is 300 μA maximum. The T/Itrip input is 4.3V nominal and the under voltage lockout voltage is 11V.

In FIG. 1, the motor phase outputs are indicated at U, V and W. Non-punch through (NPT) IGBTs and hyperfast diodes are preferably used in the power module for fast switching without excessive ringing.

The circuit of FIG. 1 has the collectors of the high side IGBTs 20, 30, 40 connected together to the V+ bus rail. The emitters of the high side IGBTs are connected to the collectors of the respective low side IGBTs 50, 60, 70. The respective common points are provided as the motor drive phase outputs U, V and W and also to respective inputs of the driver chip 80.

The emitters of the low side IGBTs 50, 60 and 70 are provided to external terminals VRU, VRV and VRW, where they can be connected as desired, for example, to emitter shunt resistors for feedback and monitoring of the motor current. This provides greater flexibility in connection of the module. Typically, in prior art modules, the low side emitters are connected together and brought outside the module as a single, terminal, reducing flexibility. In FIG. 1, emitter shunts RE1, RE2 and RE3 have been shown. These can be use for feedback monitoring purposes.

Control inputs from a controller, such as a microprocessor, are provided on lines HIN1-HIN3 and LIN1-LIN3. VSS is coupled to the substrate ground, preferably an insulated metal substrate (IMS), as described below.

In order to improve EMI performance, prior art modules use slower PT (punch through) IGBTs with switching times around 1 μs. The higher switching losses resulting from slower switching are offset by the lower conduction losses of the PT IGBTs.

A comparison of the turn-on and turn-off switching waveforms of the module of the invention and the prior art is shown in FIGS. 1(a) and 1(b). It is apparent that both turn-on and turn-off di/dt rates are higher for the module of the invention. The prior art module also shows higher tail current during turn-off, typical of PT IGBTs.

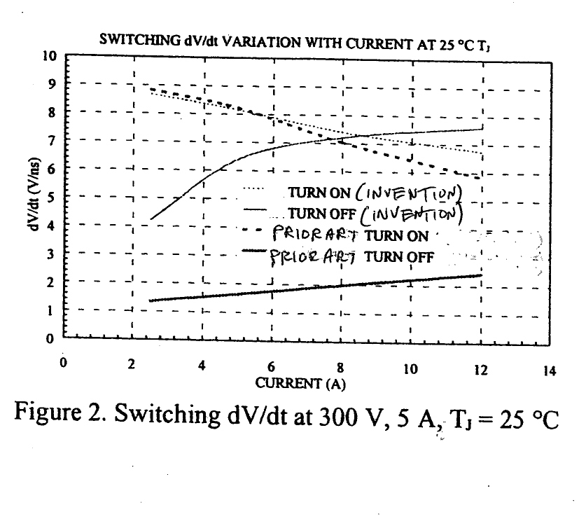

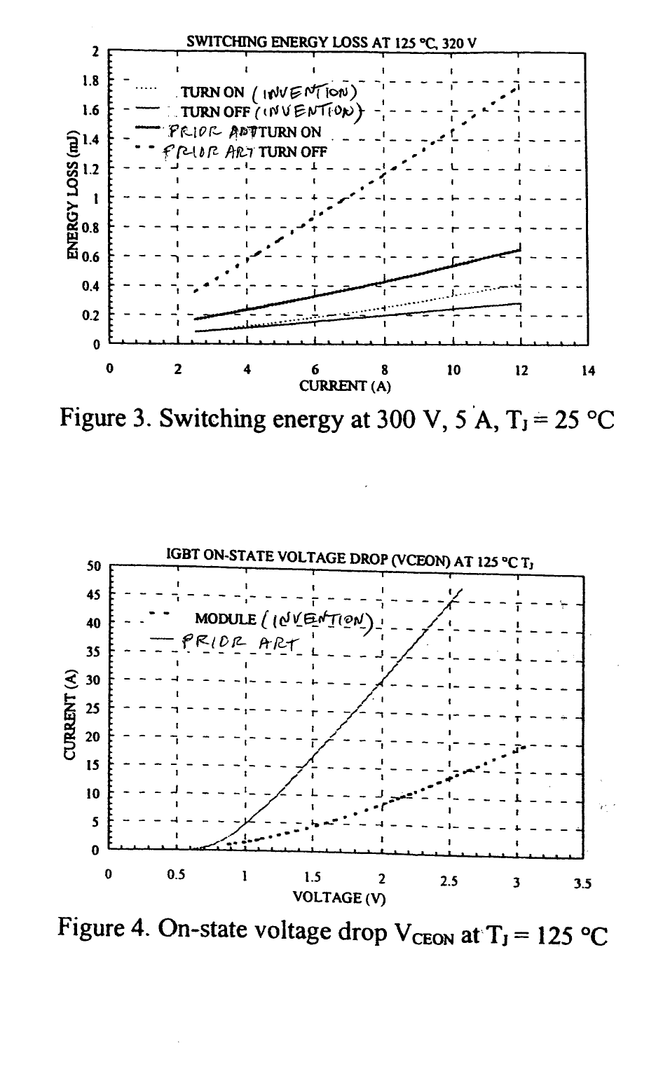

A chart indicating the variation of switching dV/dt rates with switching current is shown in FIG. 2. While turn-on dV/dt is similar, the turn-off dV/dt is much lower in the prior art device (1.63 V/ns for prior art versus 6.38 V/ns for the inventive module at 5 A, Tⱼ=25° C.).

Forward conduction voltages (V_{CEON}) are shown in FIG. 4. The prior art device has a lower V_{CEON} than the invention (˜1 V vs 1.6 V at 5 A, Tⱼ=125° C.). Based on the above measurements and knowing the operating conditions, total module power losses in a module driving an air-conditioner compressor were calculated. The procedure used for this calculation is briefly described.

The complexity associated with making accurate physics-based models suggests that a more pragmatic approach could be used. This would involve measuring elemental energy losses and calculating total power losses using system level models. Switching losses for the IGBTs and diodes can be measured and modeled empirically as functions of voltage and current. Similarly, on-state voltage drop can be represented as a function of current.

E_{ON}=(h1+h2.I^{x})I^{K}

E_{OFF}=(m1+m2.I^{y})I^{N}

V_{CEON}=V_{T}+aI^{b} (1)

In equations (1), V_{T} is the voltage drop across the IGBT/diode at zero current and h1, h2, x, k, m1, m2, y and n are empirical parameters obtained to get a good curve fit between measured and calculated values.

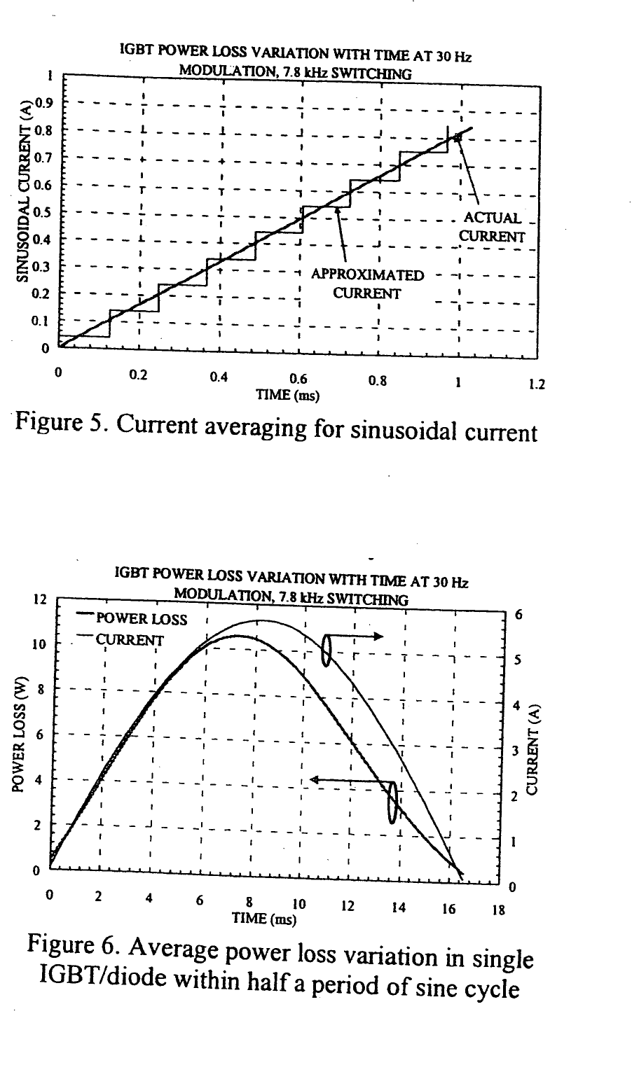

Knowing the switching frequency in the application, the energy losses can be averaged per switching cycle giving power loss per switching cycle. Assuming that the current varies linearly within one switching cycle and the variation is small, the average current in the switching cycle can be assumed to be constant throughout the switching period. This is shown in FIG. 5. The value of this average switch current follows the output current waveform, e.g., a sine wave for sinusoidal current.

The switching energies at turn-on and turn-off, and the conduction drop can be calculated for each switching cycle using equations (1), and averaged giving a time-variant power loss as shown in FIG. 6. This figure shows power loss variation with a sinusoidal current for half a modulation cycle i.e., for one IGBT. Knowing this variation, the average power loss can be calculated per IGBT (or diode) and for a 3-phase inverter system.

Typically, the inverter power module is mounted on a forced-air cooled heat sink, and thus, temperature variation of the heat sink is small with change in module power dissipation. Power losses can be estimated using the methodology described above under the maximum compressor load conditions: V_{BUS}=390V, f_{sw}=7.8 kHz, motor current=4A RMS (sinusoidal), PF=0.7, modulation index=0.8 at junction temperatures of 25° C. and 125° C. In on actual application, the junction temperature is estimated to be not more than 75 to 80° C. so a number somewhere in the middle between the two estimated limits would represent the actual power losses.

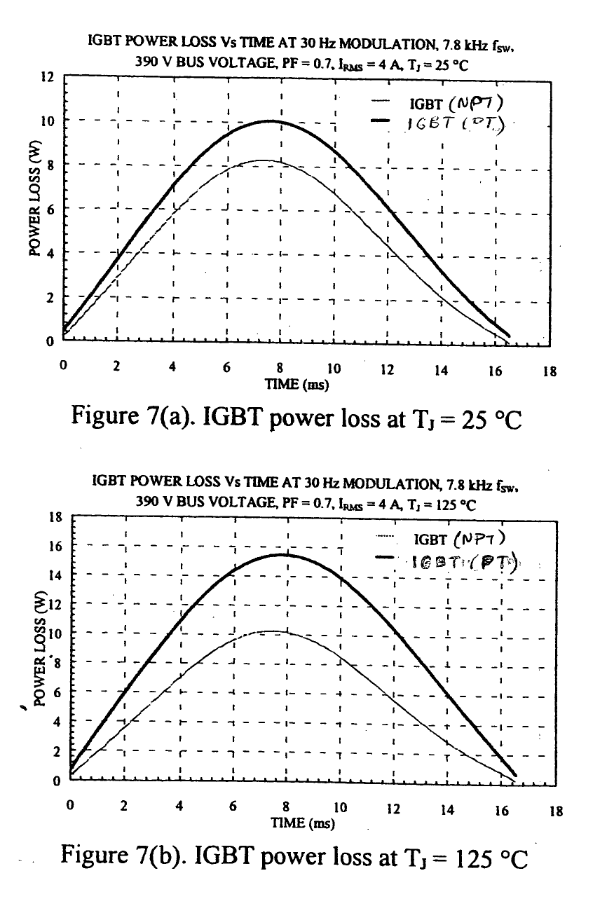

Power loss variation with time under the conditions above and 30 Hz modulation frequency is shown in FIGS. 7(a) and (b). The average power losses per IGBT and in the complete inverter are listed in Table 1(a) and (b) Note that total power losses include diode power losses. It is clearly seen that power losses are much lower in the module of the invention on account of the much faster switching speeds and consequently lower switching losses.

TABLE 1(a)
Average power loss, distribution at 25° C.

| Losses | Invention | Prior Art |
|---|---|---|
| IGBT conduction (W) | 1.70 | 1.43 |
| IGBT switching (W) | 0.63 | 1.64 |
| IGBT total (W) | 2.33 | 3.07 |
| Total inverter losses (W) | 18.1 | 22.9 |

TABLE 1(b)
Average power loss distribution at 125° C.

| Losses | Invention | Prior Art |
|---|---|---|
| IGBT conduction (W) | 1.89 | 1.31 |
| IGBT switching (W) | 1.02 | 3.47 |
| IGBT total (W) | 2.91 | 4.78 |
| Total inverter losses (W) | 21.3 | 34.0 |

Prior art modules, as stated earlier, have lower conduction losses than the invention. Because the prior art device is a PT device rated at 20A, the conduction losses are inversely proportional to temperature. On the other hand, for the module of the invention using NPT IGBTs, conduction losses increase with temperature. However, the significant difference is due to switching losses, especially at higher junction temperatures, where the prior art modules show higher sensitivity than the modules of the invention. Since the actual operating temperature is estimated to be not more than 75-80° C., the total power losses would be about 27-28 W for the prior art device compared with 19-20 W for the module of the invention.

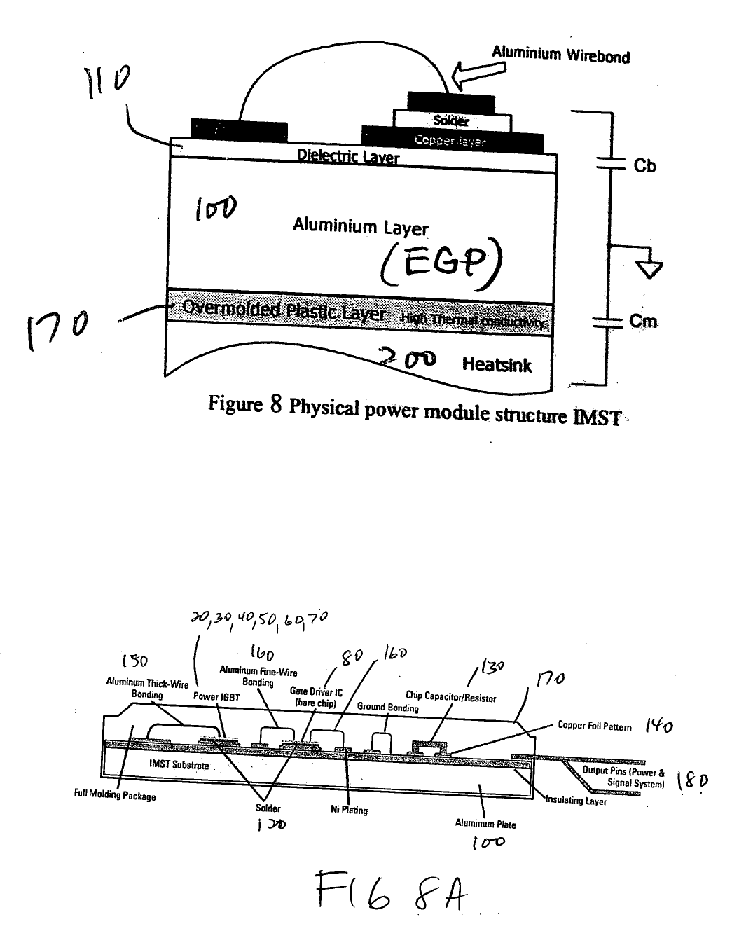

FIG. 8 shows the IMST structure of the module of the invention. Starting from the IMST structure mentioned earlier, the aluminum layer 100 of FIG. 8 is also a good electrical conductor and it can be used, via wire bonding connection, as an internal ground layer serving as an Equipotential Ground Plane (EGP). It functions as a ground plane but not as the equipotential point for the power module internal circuitry.

Typical PCB boards in the appliance industry are, for cost reasons, one or two layers. This forces the designer to implement single point grounding techniques. A single point ground connection is one in which several ground returns are tied to a single reference point. The intent of this single point ground location is to prevent currents from the power section flowing to the logic ground section of the system via common current paths.

FIG. 8A shows details of the module structure. The structure employs an IMST substrate comprising an aluminum plate 100, an insulating layer 100, solder bumps 120 for the IGBTs 20-70 and the gate driver 80 and passive components 130 soldered to copper foil patterns 140. The gate driver IC 80 and IGBTs are wire bonded (150, 160). The package is overmolded (170) and external terminals 180 are provided for connections. The overmolded package is mounted on a heatsink 200, shown in FIG. 8.

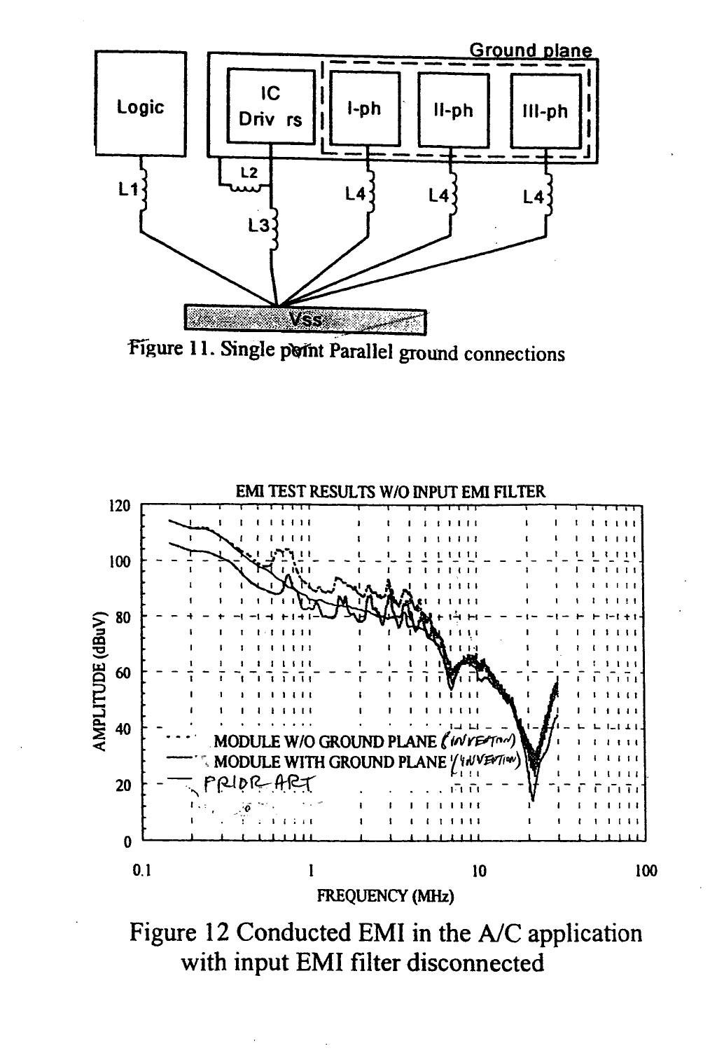

The grounding scheme commonly used in appliance applications is shown in FIG. 11. Distributed capacitance is also present among the circuitry and ground. When both inductance and capacitance are present, noise transients are generated by the ringing triggered by fast dV/dt's in the circuit.

High frequency loops must be kept as small as possible in order to reduce radiated RFI. Reducing the impedance in the high frequency loop by adding a high frequency capacitor in parallel to the RF path greatly reduces RFI.

The combination of the EGP and the positive input rail provides a distributed high frequency capacitor located inside the power module. It is connected in parallel with the bulk smoothing capacitors creating a low impedance path for the high frequency currents generated by the inverter. It also contributes to differential mode RFI attenuation reducing the conducted noise of the motor drive. The IGBT dies are mounted on the IMS substrate with the high side emitter and the low side collector forming a switching node. This node switches the DC bus voltage and is the source of the generated wide band RFI. The equivalent capacitor from this node to the ground plane Cb is shown in FIG. 8. This capacitor conducts both differential and common mode noise.

For differential mode noise, Cb plays an important role. It acts as a snubber network for the turn-on and turn-off transients, to reduce the radiated noise. The distributed high frequency bus capacitor located inside the power module is denoted by Ca. It reduces the high frequency loop size thus confining the RF currents very close to the noise source. FIG. 9 shows the differential mode currents relating to a single inverter leg.

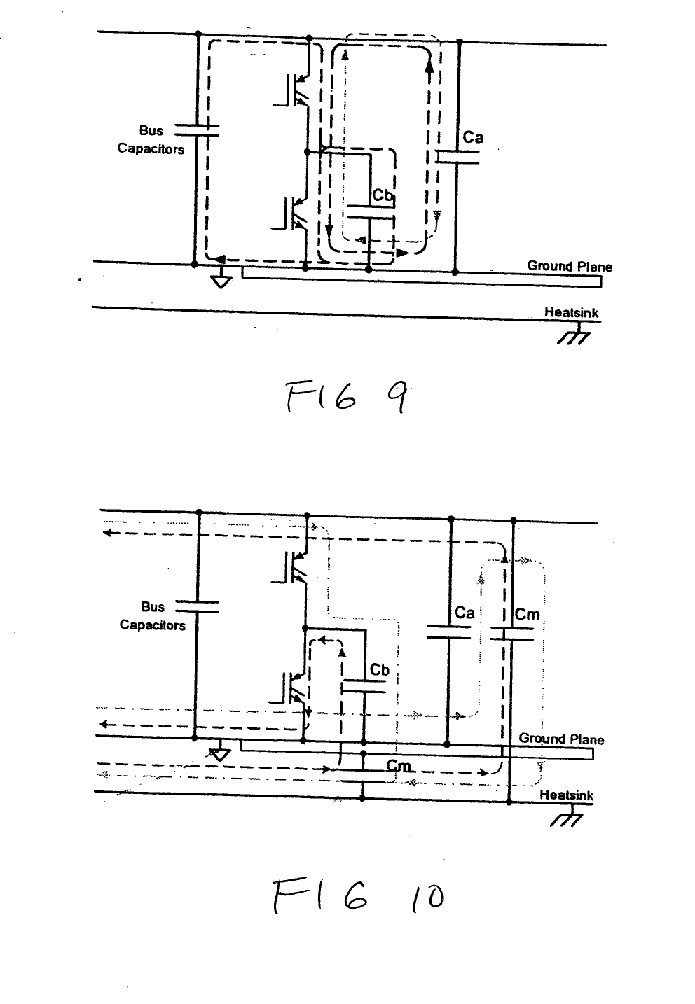

Common mode noise is injected into the heat sink via the distributed circuit capacitances between the heat sink and the input rail. In some cases, the heat sink is grounded to the equipment enclosure and this path forms the connection to inject common mode noise. If the metal substrate is connected to the DC return bus instead of being grounded or floating, it improves the attenuation of common mode noise by shielding the source. The common mode paths are represented by the Cm capacitors shown in FIG. 10. The dashed lines indicate the common mode current paths. In FIG. 10, the ground plane (IMS aluminum layer) is connected to ground as shown, thereby acting as a shield to block noise.

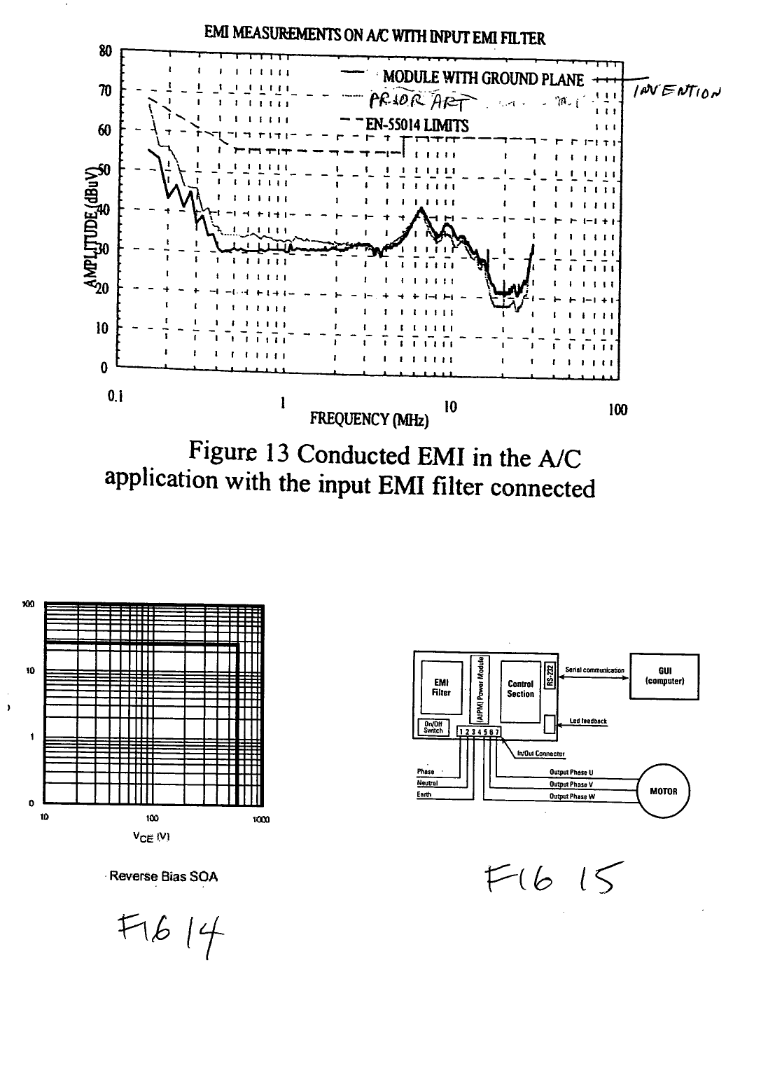

The module of the invention was tested in a variable speed air conditionig compressor drive to verify the hypothesis made for the IMST structure. The equipment under test is a commercial 1.4 kW split system air-conditioner, operating from 230V, 50/60 Hz one phase mains. The prior art technology using PT IGBTs was also tested. FIGS. 12 and 13 show the EMI test comparisons between the prior art module and the present invention. The tests compare the modules with and without the ground plane connection to verify the effectiveness of this technique.

The EMI tests were made as described in specification EN55014 “Requirements for household appliances, electric tools and similar apparatus”. Conducted EMI measurements were made with and without the built in passive input pi filter. FIG. 12 shows the performance of the prior art module with and without the aluminum substrate grounded, and a prior art module. The advantage of the ground plane connection is shown in FIG. 12. In spite of its faster switching, the noise generated by the invention is about 5 dBμV lower than the prior art module in the <1 MHz range. It is also noted that FIG. 12 shows the results without the input EMI filter at maximum compressor speed. This is the worst-case as far as EMI generation is concerned. The present invention produces lower noise than the prior art module because of the ground plane connection.

Air conditioners rarely work continuously at maximum speed so in order to provide a more realistic comparison, the input EMI filter was reconnected and additional tests were performed at average compressor speed. FIG. 13 shows the conducted noise performance with the system in the original configuration. From FIG. 13 it is apparent that the aluminum plate lowers noise in the differential mode, up to 1 MHz, and partially in the common mode up to 5 MHz. Beyond 5 MHz the present invention becomes slightly noisier because the substrate grounding is less effective.

Accordingly, the performance of the module of the invention in an actual application shows lower overall power losses compared with prior art technology even at higher switching speed, which yields better efficiency. Despite the higher dV/dt, superior conducted EMI performance was demonstrated using the ground plane integrated within the structure of the power module. The dies used in the module of the invention were smaller than the ones used in the prior art module, allowing achieving even lower costs, while maintaining superior performance. In summary, the module of the present invention provides a viable replacement alternative for appliance motor drives and other light industrial drive applications.

Because the IC Driver employed in this design is intelligent, it provides integrated temperature monitoring that enables over-temperature and over-current protection, as well as integrated under-voltage lockout function (UVLO). In addition, it incorporates advanced current sensing techniques to continuously monitor the current to enable short-circuit detection and protection. In summary, the driver delivers a high level of protection and fail-safe operation. The integrated bootstrap diodes for the high-side driver section, along with single polarity power supply for the transistors and the driver IC further simplifies the use of the power module. Since it employs positive gate driven IGBTs that do not need a negative power supply to completely turn off the device, the three-phase inverter module operates from a single polarity power supply.

The IGBT combines the advantages of providing the high input impedance of a MOSFET and the low on-state conduction loss of a bipolar transistor. Traditionally the IGBT has dominated applications that require 1000V or higher breakdown voltage. However, recent implementation of NPT techniques have boosted the IGBT's switching characteristic and fabrication cost at voltages as low as 600V, thus, making it attractive for 600 V designs with operating frequencies of 25 kHz or below. The IGBT dies employed in this design may be International Rectifier's Generation 5 IGBTs capable of switching up to 25 kHz at full rated current. They are extremely rugged switches with a square reverse bias safe operating area (RBSOA), as shown in FIG. 14.

These IGBTs can withstand short circuits for at least 10 microseconds (μs). Another attractive feature of the IGBTs incorporated in this module is better gate control of the device turn-on and turn-off.

The NPT technology also insures tighter control of device parameters like turn-on and turn-off time. As a result, the turn-on delay time for the inverter is 470 ns, and turn-off delay is 615 ns. Likewise, to maintain high efficiency, the IGBT switching energy loss is also kept to a minimum. The total switching energy loss of the inverter, a combination of turn-on and turn-off losses, is 225 μJ at 25° C. temperature for I_{c}=5A and V_{CC}=400V. For similar conditions, the switching energy loss rises to 310 μJ at 100° C.

Another major facilitator of this compact module is the highly integrated three-phase driver with the ability to withstand voltages as high as 600V. By incorporating three independent half-bridge driver circuitry, as well as associated logic inputs and required protection features for all the three phases (or six channels) of the IGBT bridge, the monolithic high voltage driver IC dramatically cuts the need for external components. With this level of integration on-chip, it significantly reduces the wiring inside the module, as well as the interconnect paths, to reduces parasitic losses and further improve the efficiency of the three-phase inverter. In short, it enables an intelligent power module that simplifies the construction of a three-phase inverter for ac motors.

Some of the salient features of the high-voltage three-phase driver IC include floating channel for bootstrap operation, tolerance to negative transient voltage, dV/dt immunity, wide gate drive range (10-20V), UVLO for all channels, over-current shut down for all six drivers, matched propagation delay for all channels, cross-conduction prevention logic, lower di/dt gate driver for noise immunity, and externally programmable delay for automatic fault clear. Its current trip function, which terminates all the six outputs, is derived from an external current sense resistor. In the disclosed design, a negative temperature coefficient thermistor is utilized for over temperature protection. Furthermore, the bridge driver ensures a dead time of 200 ns to permit high frequency switching.

To maximize performance of the module, the capacitors, whether bootstrap or DC bus, should be mounted as close to the module pins as possible to reduce ringing and EMI problems. While low inductance shunt resistors should be utilized for phase leg current sensing, the length of the traces between pins 12, 13 and 14 (VRU, VRV, VRW) (FIG. 1) to the corresponding shunt resistor should be kept as short as possible.

For evaluating the module, a demo board with application software can be provided. This board may be based on an 8-bit microcontroller used to implement the control loop for the module that generates the pulse-width modulated (PWM) output current (U, V, W) for the motor. The motor drive inverter module on this demo board may be a three-phase, 230 V input, 0.5 horsepower (350 W) ac PWM drive. Also, an opto-isolated serial link interface GUI via RS-232 may be provided. In addition, also provided are protection against short circuit, fault and over-temperature, high-frequency input EMI filter, on/off switch and +15 and +5 V supplies. FIG. 15 illustrates all functional blocks on this board with typical connections.

The module of the invention provides an integrated thermistor temperature sensor that enables over-temperature and over-current protection, as well as integrated undervoltage lockout function (UVLO). In addition, the module features low side emitter output pins for advanced current sensing techniques utilizing external shunts on each motor phase to continuously monitor the current and enable short-circuit detection and protection. In summary, the IPM provides a high level of protection that supports fail-safe operation.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. An inverter power module for driving an electric motor comprising:
a plurality of motor drive power switches having at least one output for driving the motor;
a driver integrated circuit for driving the plurality of motor drive power switches;
the plurality of switches comprising at least two power switches arranged in a half bridge configuration adapted to be connected between rails of a supply bus, with a common connection between the switches serving as an output for driving the motor, the switches comprising a high side switch and a low side switch, the low side switch being connected to an external terminal of the module adapted to be connected through a sensing element to a lower potential supply bus rail, whereby a motor current can be monitored at the external connection.

2. The power module of claim 1, wherein the plurality of switches comprise three pair of switches each arranged in a half bridge and adapted to be connected between the supply bus rails and each pair having a common connection serving as a respective motor drive output for driving a respective phase of the motor, and wherein each low side switch is connected to an external terminal of the module and adapted to be connected to a sensing element.

3. The power module of claim 2, wherein the sensing element comprises an external shunt resistor or current transformer for monitoring the motor current in a respective motor phase.

4. The power module of claim 2, wherein the switches are IGBTs.

5. The power module of claim 4, wherein the IGBTs are non punch through IGBTs.

6. The power module of claim 1, further comprising at least one bootstrap diode integral to the module coupled to the driver integrated circuit and being coupled to an external terminal for coupling to a bootstrap capacitor.

7. The power module of claim 1, wherein the switches and driver IC are mounted on an insulated metal substrate (IMS).

8. The power module of claim 7, wherein the IMS forms a ground plane coupled to the external terminal of the low side switch.

9. The power module of claim 8, wherein the IMS functions as a shield for EMI.

10. The power module of claim 9, wherein the IMS is direct current insulated from a heat sink for the power module.

11. The power module of claim 1, further comprising an overcurrent/overtemperature detection circuit for detecting if the module has exceeded a preset temperature and if the current to the motor has exceeded a present current, and a trip terminal of the module connected to said driver IC for turning the switches off if either the temperature or current has exceeded the preset levels.

12. The power module of claim 11, wherein the trip terminal connected to the driver IC functions both to receive an overcurrent signal and to provide an overtemperature signal to an external monitoring circuit.

13. The power module of claim 11, wherein the trip terminal also functions to detect an overvoltage condition.

14. The power module of claim 11, wherein the overcurrent/overtemperature detection circuit comprises a temperature sensitive component.

15. The power module of claim 13, wherein the temperature sensitive component comprises a thermistor.

16. The power module of claim 6, wherein the at least one bootstrap diode is integral to the module.

17. An inverter power module for driving an electric motor comprising:
a plurality of motor drive power switches having at least one output for driving the motor;
a driver integrated circuit for driving the plurality of motor drive power switches;
the plurality of switches comprising at least two power switches arranged in a half bridge configuration adapted to be connected between rails of a supply bus, with a common connection between the switches serving as an output for driving the motor, the switches comprising a high side switch and a low side switch, further comprising at least one bootstrap diode integrated in the module and having one diode terminal connected to an external terminal of the module, the external terminal being adapted to be connected to a bootstrap capacitor.

18. the power module of claim 17, wherein the low side switch is connected to an external terminal of the module adapted to be connected through a sensing element to a lower potential supply bus rail, whereby a motor current can be monitored at the external connection.

19. The power module of claim 17, wherein the plurality of switches comprises three pair of switches each arranged in a half bridge and adapted to be connected between the supply bus rails and each pair having a common connection serving as a respective motor drive output for driving a respective phase of the motor, and wherein each low side switch is connected to an external terminal of the module and adapted to be connected to a sensing element.

20. The power module of claim 19, wherein the sensing element comprises an external shunt resistor or current transformer for monitoring the motor current in a respective motor phase.

21. The power module of claim 19, wherein the switches are IGBTs.

22. The power module of claim 21, wherein the IGBTs are non punch through IGBTs.

23. The power module of claim 17, further comprising a plurality of integral bootstrap diodes coupled to the driver integrated circuit and being coupled to external terminals for coupling to bootstrap capacitors.

24. The power module of claim 17, wherein the switches and driver IC are mounted on an insulated metal substrate (IMS).

25. The power module of claim 24, wherein the IMS forms a ground plane coupled to the external terminal of the low side switch.

26. The power module of claim 24, wherein the IMS functions as a shield for EM1.

27. The power module of claim 26, wherein the IMS is direct current insulated from a heat sink for the power module.

28. The power module of claim 17, further comprising an overcurrent/overtemperature detection circuit for detecting if the module has exceeded a preset temperature and if the current to the motor has exceeded a present current, and a trip terminal of the module connected to said driver IC for turning the switches off if either the temperature or current has exceeded the preset levels.

29. The power module of claim 28, wherein the trip terminal connected to the driver IC functions both to receive an overcurrent signal and to provide an overtemperature signal to an external monitoring circuit.

30. The power module of claim 28, wherein the overcurrent/overtemperature detection circuit comprises a temperature sensitive component.

31. The power module of claim 30, wherein the temperature sensitive component comprises a thermistor.

32. An inverter power module for driving an electric motor comprising:
a plurality of motor drive power switches having at least one output for driving the motor;
a driver integrated circuit for driving the plurality of motor drive power switches;
the plurality of switches comprising at least two power switches arranged in a half bridge configuration adapted to be connected between rails of a supply bus, with a common connection between the switches serving as an output for driving the motor, the switches comprising a high side switch and a low side switch;
further comprising an overcurrent/overtemperature detection circuit for detecting if the module has exceeded a preset temperature and if the current to the motor has exceeded a present current, and a trip terminal of the module connected to said driver IC for shutting down the module if either the temperature or current has exceeded the preset levels.

33. The power module of claim 32, wherein the low side switch connected to an external terminal of the module adapted to be connected through a sensing element to a lower potential supply bus rail, whereby a motor current can be monitored at the external connection.

34. The power module of claim 32, wherein the plurality of switches comprises three pair of switches each arranged in a half bridge and adapted to be connected between the supply bus rails and each pair having a common connection serving as a respective motor drive output for driving a respective phase of the motor, and wherein each low side switch is connected to an external terminal of the module and adapted to be connected to a sensing element.

35. The power module of claim 32, wherein the sensing element comprises an external shunt resistor or current transformer for monitoring the motor current in a respective motor phase.

36. The power module of claim 32, wherein the switches are IGBTs.

37. The power module of claim 36, wherein the IGBTs are non punch through IGBTs.

38. The power module of claim 32, further comprising at least one bootstrap diode integral to the module coupled to the driver integrated circuit and being coupled to an external terminal for coupling to a bootstrap capacitor.

39. The power module of claim 32, wherein the switches and driver IC are mounted on an insulated metal substrate (IMS).

40. The power module of claim 39, wherein the IMS forms a ground plane coupled to the external terminal of the low side switch.

41. The power module of claim 39, wherein the IMS functions as a shield for EM1.

42. The power module of claim 41, wherein the IMS is direct current insulated from a heat sink for the power module.

43. The power module of claim 32, wherein the trip terminal connected to the driver IC functions both to receive an overcurrent signal and to provide an overtemperature signal to an external monitoring circuit.

44. The power module of claim 32, wherein the overcurrent/overtemperature detection circuit comprises a temperature sensitive component.

45. The power module of claim 44, wherein the temperature sensitive component comprises a thermistor.

46. The power module of claim 32, wherein the trip terminal also functions to detect an overvoltage condition.
